(19) United States
(12) Patent Application Publication
(10) Pub. No.: US 2012/0059682 A1
(43) Pub. Date: Mar. 8, 2012

(54) CONTINUOUS IMPROVEMENT FOR A PROCEDURE MANAGEMENT SYSTEM TO REDUCE THE INCIDENCE OF HUMAN PROCEDURE EXECUTION FAILURES

(75) Inventors: Liana Maria Kiff, Minneapolis, MN (US); Anand Tharanathan, Plymouth, MN (US); Peter Bullemer, Independence, MN (US)

(73) Assignee: HONEYWELL INTERNATIONAL INC., Morristown, NJ (US)

(21) Appl. No.: 13/027,611

(22) Filed: Feb. 15, 2011

Related U.S. Application Data
(60) Provisional application No. 61/380,054, filed on Sep. 3, 2010.

(51) Int. Cl. G06Q 10/00

(52) U.S. Cl. 705/7.27

(57) ABSTRACT

A method of continuously improving a procedure management system that generates human operating procedures. At least one failure mode (“root cause”) is defined for each human procedural execution failure. The root causes are mapped to stages of human operator execution for the human operating procedures where the plurality of root causes manifest, and to human intervention activities that the human operator failed to correctly execute (“procedure deficiency”). Each root cause is mapped to one or more procedure management components that may have generated the procedure deficiency. Recorded actual incidents of human procedural execution failures are analyzed to identify at least one assignable root cause. A procedure management component is updated to mitigate the assignable root cause, and is then used to change at least one human operating procedure or to generate a new human operating procedure to reduce an incidence of the human procedural execution failures.

### CROSS REFERENCE TO RELATED APPLICATIONS

This application and the subject matter disclosed herein claims the benefit of Provisional Application Ser. No. 61/380,054 entitled “ANALYZING PROCEDURE EXECUTION FOR GENERATING CORRECTIVE ACTION THAT MITIGATES PROCEDURE EXECUTION FAILURE MODES FOR AN INDUSTRIAL PROCESS”, filed Sep. 3, 2010, which is herein incorporated by reference in its entirety.

### FIELD

Disclosed embodiments relate to tools for updating a procedure management system that generates human operating procedures that reduce the incidence of human operator procedure execution failure.

### BACKGROUND

Procedures for human operators play an important role in the management of complex systems, such as work processes (e.g., processes run by processing plants). Procedures range from entirely manual and paper-based procedures to highly automated and electronic procedures. Despite many years of study that procedure lifecycle management, procedure formatting, procedure content and procedure policy, human procedure execution is still highly inconsistent, procedure documentation is inconsistently developed and presented, and procedures generally fail to provide the benefits that they are intended to deliver (e.g., operational consistency, and improved safety).

Though guidelines exist for improving procedure development and management of processes, such guidelines do not systematically identify failures in a procedure management system or procedure execution process. Therefore, problems tend to persist because they are difficult to identify or fix, and in some situations lead to the loss of life and/or property.

SUMMARY

Disclosed embodiments include methods that can be part of a continuous improvement process for procedure management systems where actual, recorded procedural human operator errors are the primary data utilized by the methods. Disclosed methods focus on an analysis of procedure execution to affect improvement in procedure design. Unlike conventional process-oriented failure modes and effect-based analysis (PFMEA) methods that center on the risk of an error occurring based an analysis of a specific task/process, there is no need for disclosed embodiments to calculate the risk of an error occurring. Moreover, unlike PFMEA, generally all manifested and documented errors are examined regardless of risk or severity, as it is both the individual procedure and the procedure management system that are the subject of analysis and remedial action. Disclosed methods specifically identify where in the process for developing and delivering procedures, or training for procedures, that is responsible for the procedure deficiency. Since disclosed methods are designed to address systemic issues that lead to procedure deficiencies, all procedures within the environment can be expected to improve over time due to improvements in the procedure management system itself, thus providing continuous improvement for procedure management systems.

One disclosed embodiment comprises a method of continuously improving a procedure management system comprising a plurality of procedure management components that generates human operating procedures for a human operator to execute. At least one of a plurality of specific and actionable failure modes (“root cause”) is defined for each of a plurality of human procedural execution failures. The plurality of root causes are mapped to at least one of a plurality of stages of human operator execution for the human operating procedures where the plurality of root causes manifest, and to at least one of a plurality of human intervention activities that the human operator failed to correctly execute (“procedure deficiency”). Each of the plurality of root causes are mapped to at least one of the plurality of procedure management components that may have generated the procedure deficiency.

Recorded actual incidents of human procedural execution failures (e.g., stored in a database) are analyzed to identify at least one assignable root cause from the plurality of root causes. At least one of the plurality of procedure management components are updated to mitigate the assignable root cause. After the updating, the procedure management system is used to change at least one human operating procedure or to generate a new human operating procedure, where the change to the human operating procedure or addition of a new human operating procedure reduces an incidence of repeating the human procedural execution failure.

### BRIEF DESCRIPTION OF THE DRAWINGS

FIG. 1 is a table that provides an example root cause analysis results summary of procedure related root causes relevant to execution in abnormal situations derived from a data set including 32 reported incidents, according to an example embodiment.

FIG. 2 is an example illustration of a subset of the relationships between procedure management system components of a procedure management system and stages of human procedure execution, according to an example embodiment.

FIG. 3 is a flow chart that shows steps in a method of continuously improving a procedure management system comprising a plurality of procedure management components that generates human operating procedures to reduce an incidence of human procedural execution, according to an example embodiment.

FIG. 4 is a block diagram of a system for updating procedure management system components of a procedure management system to generate revised procedures that reduces an incidence of human procedural execution failures, according to an example embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments. One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

Disclosed embodiments provide systems, methodologies and software products for continuously improving a procedure management system comprising a plurality of procedure management components that generates human operating procedures for a human operator to execute, that provide continuous improvement that reduce the risk of repeating human execution failures (root causes). Disclosed embodiments are enabled by more clearly defining the root causes to a level of detail that allows for specific solutions to be identified and implemented, based on the nature of the failure, and the particular impact of that failure on the human operator executing the procedure. This is a significant improvement over existing systems of analysis of procedure environment, such as PFMEA which can result in misinterpreting the real root cause, or providing only vague suggestions for procedural improvements.

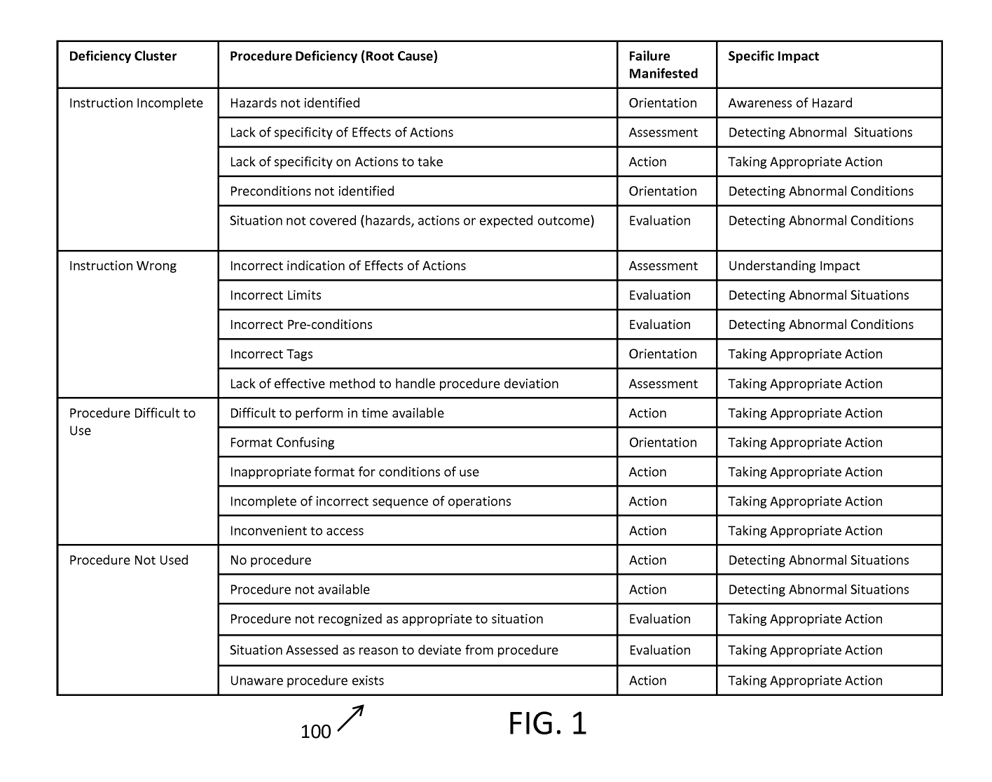

FIG. 1 is a table 100 that provides an example root cause analysis results summary of procedure related root causes relevant to execution in abnormal situations derived from a data set including 32 reported incidents. A root cause is defined herein as the most basic cause (or causes) that can reasonably be identified that management has control to fix and, when fixed, will prevent (or significantly reduce the likelihood of) the failure's (or factor's) recurrence. A root cause as defined herein describes why a failure occurred.

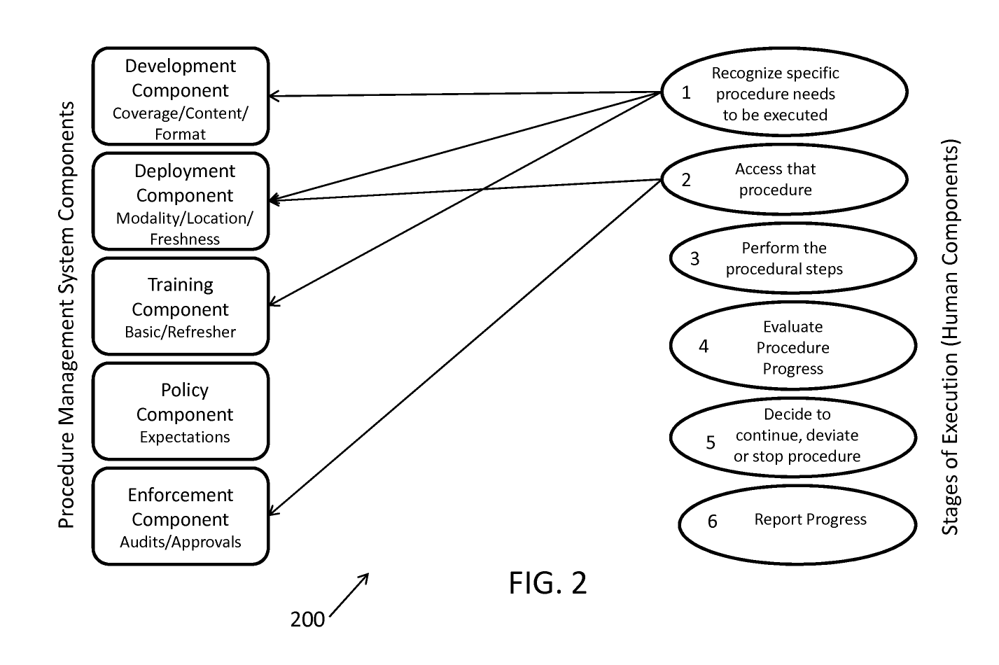

FIG. 2 is an example illustration 200 of a subset of the relationships between procedure management system components of a procedure management system, and stages of human procedure execution, according to an example embodiment. A procedure management system is defined herein to be a set of processes and tools that an organization (e.g., business, government, industrial plant) puts in place to support the development, deployment, organization, training, change to, and generation of human operator procedures. This generally includes more than one tool and potentially several work processes or management policies that define how procedures are managed over time, what they should look like, what information they should contain, and who is responsible for all activities related to procedure maintenance. It is possible to do this without a purpose-built procedure management software package, and organizations can just use a document management system and a set of policies or work practices. Therefore, as used herein a “procedure management system” does not necessarily mean a self-contained software system for procedure management.

Procedure management components comprise at least a collected set of documented policies and procedures for aspects of the procedure management system, such as procedure development, procedure deployment, procedure training, procedure monitoring and reporting and management of change. Procedure development practices are specific work processes that make up the procedure management system. This can be any part of the system, human or software, that is used to support the development of procedures. Example human intervention activities include orientation: identifying the situation, acquiring data about what is currently happening, evaluation/analysis: assessing the situation and determining what the right corrective action is, action: taking the corrective action, assessment: determining if the corrective action had the desired effect on the process. Such stages of human intervention are known in the field of human factors, such as based on a model disclosed by the Chemical Manufacturers Association and Endsely (1995) (Endsley, M. R. (1995). Measurement of situation awareness in dynamic systems. Human factors, 37(1), 65-84). Disclosed embodiments can associate human procedure execution failures with a failure of one of these steps in an operator's cognitive processing of the situation.

Illustration 200 is a partial example of relations between stages of operator execution and procedural management system components. The procedure management system that affect human performance shown in FIG. 2 are a development component (coverage, content and format/presentation), deployment component (modality of presentation, location, freshness/currency), training component (basic/refresher on the procedures and procedure policies), policy component (expectations) and enforcement component. The “stages of execution (human component” of the procedure represent things that the human operator needs to do correctly in order to execute the right procedure, for the right reason, and execute it correctly. The stages of execution shown in FIG. 1 include recognizing that a procedure should be executed, accessing the correct procedure, performing the procedure correctly, evaluating the progress and effect of the procedure, determining whether to continue, deviate or abort a procedure, and reporting on the progress of the procedure.

The Inventors have recognized that one or more root causes manifest themselves in human operator execution failures. These operator execution failures can be traced back (see arrows provided) to a deficiency in one or more management system components, such as the respective management system components shown in FIG. 2. In the example in FIG. 2 not all potential relations are depicted to simplify the illustration 200.

Disclosed embodiments include mapping the refined operator execution failure modes to the stage of human operator execution where they manifest, and to the specific aspect of human intervention activities that the operator failed to achieve. The human aspects of human intervention activities and response to abnormal situations can include orientation, evaluation, action, and assessment. The stages of human execution of a procedure include recognizing that a procedure should be executed, accessing the correct procedure, performing the procedure correctly, evaluating the progress and effect of the procedure, determining whether to continue, deviate or abort a procedure, and reporting on the progress of the procedure.

Disclosed embodiments generally assume that human procedure executions failures are a direct result of the overall procedure management system failing to support the human user effectively to maintain human intervention activities and correctly navigate through procedure execution. Therefore, each of a plurality of failures are mapped to one or more elements of the procedure management environment that may have failed, so that appropriate mitigating action can be identified, documented, and applied systematically to other existing procedures or to future procedures.

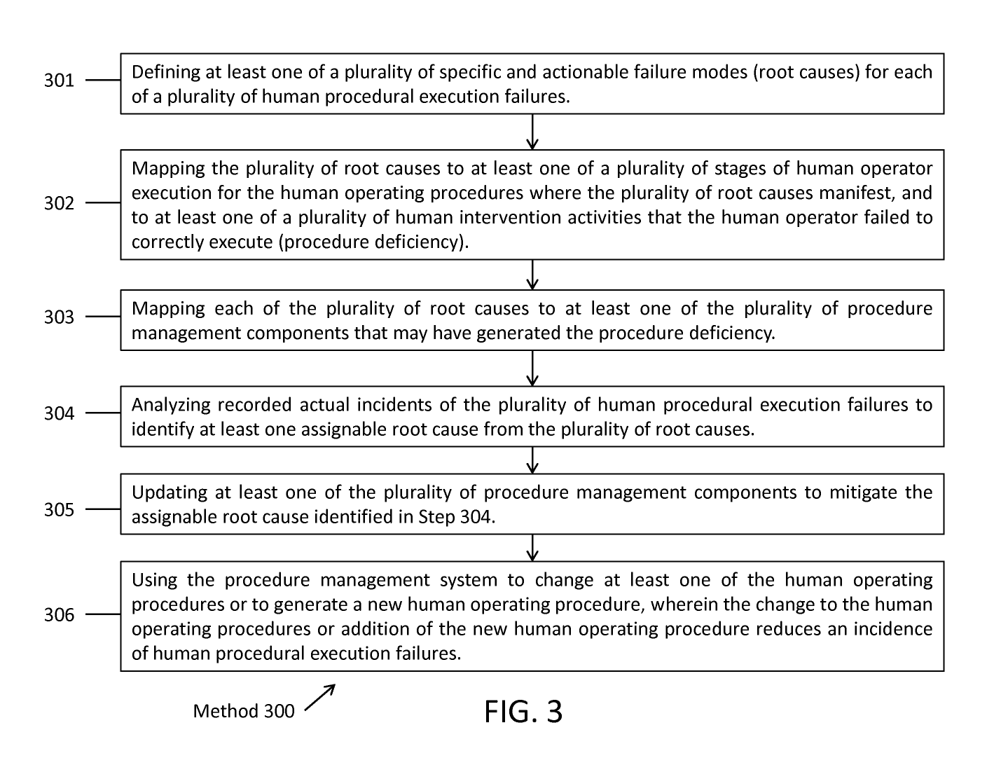

FIG. 3 is a flow chart that shows steps in an exemplary method 300 of continuously improving a procedure management system stored on a physical machine-readable storage medium (e.g., non-volatile memory device) comprising a plurality of procedure management components that generates human operating procedures to reduce an incidence of repeating human procedural execution failures while a human operator executes the human operating procedures, according to an example embodiment. Step 301 comprises defining at least one of a plurality of specific and actionable failure modes (root causes) for each of a plurality of the human procedural execution failures.

Example root causes can include human operating procedures not used, no human operating procedure, applicable human operating procedure not available, none of the human operating procedures recognized as being appropriate to a situation, situation assessed as reason to deviate from the human operating procedures, unaware the human operating procedure exists, the human operating procedure difficult to use, no access to the human operating procedures from job location of the human operator, inconvenient to access the human operating procedures, inappropriate format for conditions of use of the human operating procedures, difficult to perform the human operating procedure in time available, the human operating procedures too complex to perform, the human operating procedures providing incorrect action to take (bad setpoint), incomplete or incorrect sequence of operations provided by the human operating procedures, format of the human operating procedures confusing, instruction provided by the human operating procedures incomplete, hazards not identified by the human operating procedures, preconditions not identified by the human operating procedures, the human operating procedures lack of specificity on actions to take, the human operating procedures lack of specificity of effects of actions, situation not covered (lack of information on hazards, actions or expected outcome) by the human operating procedures, instruction provided by the human operating procedures wrong, incorrect tags provided by the human operating procedures, incorrect limits provided by the human operating procedures, incorrect pre-conditions provided by the human operating procedures, incorrect indication of effects of actions by the human operating procedures, and lack of effective method to handle procedure deviation provided by the human operating procedures.

As used herein, “specific and actionable” root causes are specific in that they specifically identify the deficiency with the type of information that is missing, which may be contrasted with non-specific and non-actionable root causes. An example of a non-specific and non-actionable human failure mode (root cause) is “instructions are incomplete.” This broad description may be interpreted by different people in a plurality of different ways. Disclosed embodiments in contrast use specific and actionable” root causes that more clearly identify the deficiency with the type of information that is missing, for example: “the instruction does not detail the potential hazards”, or, “the instruction does not detail the expected effect of the action” for the case the instructions are incomplete. This significantly higher definition level of root causes are actionable as they support targeted improvements in procedure management system components.

Step 302 comprises mapping the plurality of root causes to at least one of a plurality of stages of human operator execution for the human operating procedures where the plurality of root causes manifest, and to at least one of a plurality of human intervention activities that the human operator failed to correctly execute (procedure deficiency). Step 303 comprises mapping each of the plurality of root causes to at least one of the plurality of procedure management components that may have generated the procedure deficiency.

Step 304 comprises analyzing recorded actual incidents of the plurality of human procedural execution failures to identify at least one assignable root cause from the plurality of root causes. The recorded actual incidents of the plurality of human procedural execution failures may be stored in a suitable database, such as supported by to a non-transitory data storage media.

Step 305 comprises updating at least one of plurality of procedure management components to mitigate the assignable root cause identified in step 304. Step 306 comprises using the procedure management system to change at least one of the human operating procedures or to generate a new human operating procedure, wherein the change to the human operating procedures or addition of the new human operating procedure reduces an incidence of human procedural execution failures.

The method can further comprise generating at least one report. For example, one example report is a report that indicates which of the procedure management system components requires the most mitigation, based on detected ones of root causes and a statistical analysis of detailed findings in an examination of the recorded incidents of actual human procedure execution failures. Another example report is a report that identifies which specific ones of the human operating procedures and which specific steps within the human operating procedure are the most prone to misinterpretation by human operator or otherwise lead to deficient decisions of the human operator, based on an examination of the recorded actual incidents of human procedure execution failures. Yet another example report is a report that identifies the most likely ones of the human intervention activities to fail, evidenced by the recorded actual incidents of procedural execution failures for use to further improve specific aspects of the procedure management system to prevent similar errors in other human operating procedures, based on an examination of the recorded actual incidents of human procedure execution failures.

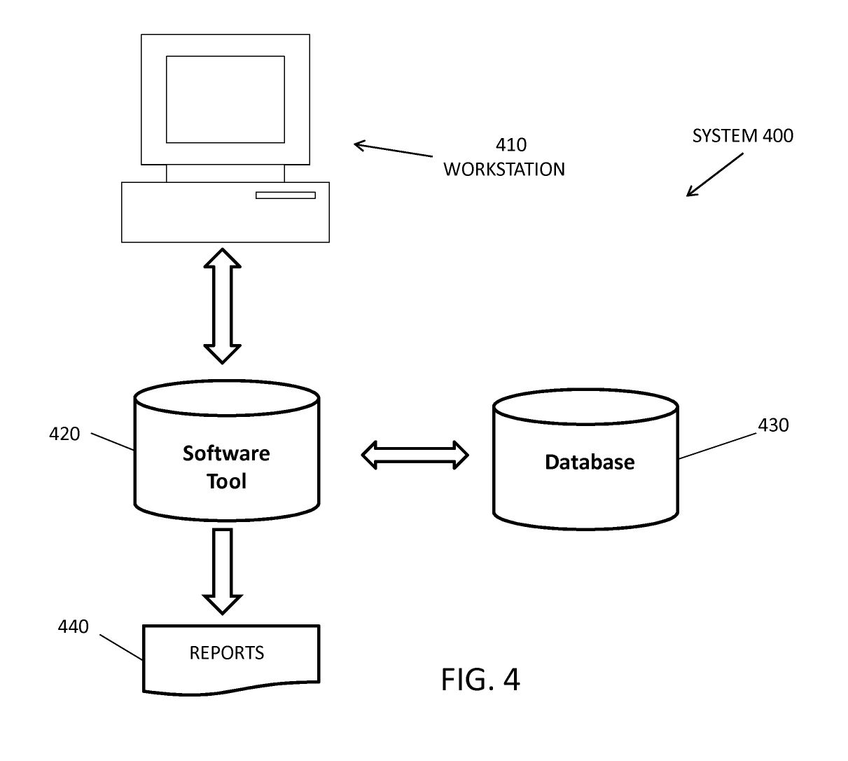

FIG. 4 is a block diagram of a system 400 for updating procedure management system components of a procedure management system to generate revised procedures that reduces an incidence of human procedural execution failures, according to an example embodiment. System 400 may be integrated into a variety of processes, such as an industrial process. System 400 includes one and generally a plurality of workstations 410 which include a user interface (e.g., keyboard) that guide a user (e.g., an analyst) through the disclosed continuously improving procedure management system methodology. Multiple workstations 410 allow multiple users to interact with the system 400. In addition to desktop workstations, other types of data processing devices can be used including handheld and portable workstations.

The user through workstation 410 interacts with a software tool 420 that includes instructions for guiding the user through the continuously improving procedure management system methodology. The software tool 420 interacts with the user through user interface associated with the workstation 410 both to elicit information from the user (e.g., actual observations of incidents of human procedural execution failure) and to guide the user through the process. The software tool 420 creates and interacts with a database 430. The database 430 includes a history of recorded actual incidents of the plurality of human procedural execution failures. The software tool 420 is operable to generate root cause assignment that generally identifies more than one root cause per observed human procedure execution failure, as well as information about the actual procedure, the step where the failure occurred, and the effect of the failure on the process.

By interacting with the database 430, the software tool 420 is operable to generate outputs including reports 440. For example, after the database is loaded with a data from a plurality of observations, the user can ask for one of several reports to be automatically generated, that would process the data regarding the observations, make the connections from root causes to procedure management system components, and report which parts of the process, and which procedures are most important to fix, such as based on the highest failure rates. Reports 440 can be in electronic or tangible form.

The software tool 420 may also allow modification of the underlying model, if, for example, it was desired to implement a procedure management system with even more distinct components, or it was desired to use names of components specific to a specific environment, or a new root cause or a new step in human cognitive processing was identified, for example. This feature allows the software product to be extensible to more complicated models, or more specific environments, as needed. The software tool 420 might also be used to document how the management system was changed and associate that change with a set of specific observations that led to that improvement. In one specific application, the whole process, including assessment and system change tracking might be used to report out to control agencies (certifiers or industry oversight bodies) or insurers who want proof of risk mitigation.

The system 400 can be implemented using any suitable software environment. In one embodiment, the system 400 is created using a database tool such as MICROSOFT ACCESS or a similar database manager. The report 440 can be generated by a word processing software tool such as MICROSOFT WORD or the like.

Disclosed embodiments include machine readable software product that can be stored on non-transitory media, that include a database that embodies the concepts and relationships described above including root causes, and relationships to the above enumerated elements.

Disclosed embodiments can be applied to generally all procedure types, and any industrial process environment where procedures play a critical role in the conduct of a work process. Disclosed embodiments may have particular benefit for processes in which the failure to execute a procedure correctly can lead to loss of life or property. For example, industrial control, nuclear plant control, air traffic control, and other safety-critical environments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

As will be appreciated by one skilled in the art, the subject matter disclosed herein may be embodied as a system, method or computer program product. Accordingly, this Disclosure can take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, this Disclosure may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include non-transitory media including the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device.

Computer program code for carrying out operations of the disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The disclosure is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a physical computer-readable storage medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

We claim:

1. A method of continuously improving a procedure management system comprising a plurality of procedure management components that generates human operating procedures for a human operator to execute, comprising:
defining at least one of a plurality of specific and actionable failure modes (root cause) for each of a plurality of human procedural execution failures;
mapping said plurality of root causes to at least one of a plurality of stages of human operator execution for said human operating procedures where said plurality of root causes manifest, and to at least one of a plurality of human intervention activities that said human operator failed to correctly execute (procedure deficiency);
mapping each of said plurality of root causes to at least one of said plurality of procedure management components that may have generated said procedure deficiency;
analyzing recorded actual incidents of said plurality of human procedural execution failures to identify at least one assignable root cause from said plurality of root causes;
updating at least one of said plurality of procedure management components to mitigate said assignable root cause, and
after said updating, using said procedure management system to change at least one of said human operating procedures or to generate a new human operating procedure, wherein said change to said human operating procedures or addition of said new human operating procedure reduces an incidence of said human procedural execution failures, wherein said procedure management system is stored on a physical machine-readable storage medium.

2. The method of claim 1, wherein said method is applied to an industrial process.

3. The method of claim 1, wherein said recorded actual incidents of said plurality of human procedural execution failures are stored in a database, wherein said database is stored in a non-transitory media.

4. The method of claim 1, wherein said method is an automatic method.

5. The method of claim 1, wherein said stages of human operator execution for said human operating procedures comprise a plurality selected from the group consisting of:
recognizing that one of said human operating procedures should be executed, accessing a correct one of said human operating procedures, performing said human operating procedure correctly, evaluating progress and effect of said human operating procedure, determining whether to continue, deviate or abort said human operating procedure, and reporting on progress of said human operating procedure.

6. The method of claim 1, wherein said plurality of operator intervention activities comprises a plurality selected from the group consisting of orientation, evaluation, action, and assessment.

7. The method of claim 1, wherein said method generates a report that indicates which of said procedure management system components requires the most mitigation, based on detected ones of said root causes and a statistical analysis of detailed findings in an examination of said recorded incidents of said actual human procedure execution failures.

8. The method of claim 1, wherein said method generates a report of which specific ones of said human operating procedures and which specific steps within said human operating procedure are the most prone to misinterpretation by said human operator or otherwise lead to deficient decisions of said human operator, based on an examination of said recorded actual incidents of said human procedure execution failures.

9. The method of claim 1, wherein said method generates a report of most likely ones of said human intervention activities to fail, evidenced by said recorded actual incidents of said procedural execution failures for use to further improve specific aspects of said procedure management system to prevent similar errors in others of said human operating procedures, based on an examination of said recorded actual incidents of said human procedure execution failures.

10. A system for continuously improving procedure management system components of a procedure management system to generate revised human operating procedures that mitigates human procedure execution failures, comprising:
at least one workstation which interacts with at least one user;
a database having recorded actual incidents stored in a non-transitory media collectively recording a plurality human procedural execution failures;
a software tool that is coupled to interact with said workstation and said datasbase, said software tool including a physical machine-readable storage medium having stored thereon computer code, said computer code comprising:
code for defining at least one of a plurality of specific and actionable failure modes (root cause) for each of said plurality of human procedural execution failures;
code for mapping said plurality of root causes to at least one of a plurality of stages of human operator execution for said human operating procedures where said plurality of root causes manifest, and to at least one of a plurality of human intervention activities that said human operator failed to correctly execute (procedure deficiency);
code for mapping each of said plurality of root causes to at least one of said plurality of procedure management components that may have generated said procedure deficiency;
code for analyzing said recorded actual incidents of said plurality of human procedural execution failures to identify at least one assignable root cause from said plurality of root causes;
code for updating at least one of said plurality of procedure management components to mitigate said assignable root cause, and
code for after said updating, using said procedure management system to change at least one of said human operating procedures or to generate a new human operating procedure, wherein said change to said human operating procedures or addition of said new human operating procedure reduces an incidence of said human procedural execution failures.

11. The system of claim 10, wherein said system is integrated into an industrial process.

12. The system of claim 10, wherein said software tool further comprises code for generating at least one report selected from (i) a report that indicates which of said procedure management system components requires the most mitigation, based on detected ones of said root causes and a statistical analysis of detailed findings in an examination of said recorded incidents of said actual human procedure execution failures, (ii) a report of which specific ones of said human operating procedures and which specific steps within said human operating procedure are the most prone to misinterpretation by said human operator or otherwise lead to deficient decisions of said human operator, based on an examination of said recorded actual incidents of said human procedure execution failures, and (iii) a report of most likely ones of said human intervention activities to fail, evidenced by said recorded actual incidents of said procedural execution failures for use to further improve specific aspects of said procedure management system to prevent similar errors in others of said human operating procedures, based on an examination of said recorded actual incidents of said human procedure execution failures.

13. A non-transitory computer-readable medium having stored instructions for continuously improving a procedure management system comprising a plurality of procedure management components that generates human operating procedures for a human operator to execute, said stored instructions comprising:
code for defining at least one of a plurality of specific and actionable failure modes (root causes) for each of a plurality of human procedural execution failures;
code for mapping said plurality of root causes to at least one of a plurality of stages of human operator execution for said human operating procedures where said plurality of root causes manifest, and to at least one of a plurality of human intervention activities that said human operator failed to correctly execute (procedure deficiency);
code for mapping each of said plurality of root causes to at least one of said plurality of procedure management components that may have generated said procedure deficiency;
code for analyzing recorded actual incidents of said plurality of human procedural execution failures to identify at least one assignable root cause from said plurality of root causes, and
code for updating at least one of plurality of procedure management components to mitigate said assignable root cause,
wherein after said updating, said procedure management system is operable to change at least one of said human operating procedures or to generate a new human operating procedure, wherein said change to said human operating procedures or addition of said new human operating procedure reduces an incidence of said human procedural execution failures.

14. The instructions for continuously improving a procedure management system of claim 13, wherein said stored instructions further comprises code for generating at least one report selected from (i) a report that indicates which of said procedure management system components requires the most mitigation, based on detected ones of said root causes and a statistical analysis of detailed findings in an examination of said recorded incidents of said actual human procedure execution failures, (ii) a report of which specific ones of said human operating procedures and which specific steps within said human operating procedure are the most prone to misinterpretation by said human operator or otherwise lead to deficient decisions of said human operator, based on an examination of said recorded actual incidents of said human procedure execution failures, and (iii) a report of most likely ones of said human intervention activities to fail, evidenced by said recorded actual incidents of said procedural execution failures for use to further improve specific aspects of said procedure management system to prevent similar errors in others of said human operating procedures, based on an examination of said recorded actual incidents of said human procedure execution failures.
